(19) United States
(12) Patent Application Publication
(10) Pub. No.: US 2022/0089463 A1
(43) Pub. Date: Mar. 24, 2022

(54) BIOPOLYMERIC WATER TREATMENT

(71) Applicant: AquOm Sciences LLC, Lakeland, FL (US)

(72) Inventor: Keith Ervin, Lakeland, FL (US)

(73) Assignee: AquOm Sciences LLC, Lakeland, FL (US)

(21) Appl. No.: 17/482,065

(22) Filed: Sep. 22, 2021

Related U.S. Application Data
(60) Provisional application No. 63/081,654, filed on Sep. 22, 2020.

(51) Int. Cl. C02F 1/28; C02F 1/66

(52) U.S. Cl. CPC C02F 1/281; C02F 1/285; C02F 2303/18; C02F 1/66; C02F 2303/20; C02F 1/286

(57) ABSTRACT

A method of in-situ treatment of a body of water comprising at least one contaminant includes adding a blended water treatment substance to the body of water. The blended water treatment substance includes at least one geopolymer and at least one cationic biopolymer. The at least one contaminant is adsorbed from the contaminated water onto the geopolymer. The at least one geopolymer upon which the at least one contaminant is adsorbed is coagulated with the at least one cationic biopolymer. The coagulated at least one geopolymer, at least one biopolymer, and at least one contaminant is precipitated to settle within the water body.

### CROSS-REFERENCE TO RELATED APPLICATION

The present Application claims priority of U.S. Provisional Patent Application 63/081,654 filed on Sep. 22, 2020, and which is incorporated by reference herein in its entirety.

### BACKGROUND

The present disclosure is related to the field of water processing and purification. More specifically, the present disclosure is related to the purification of water using polymer additives.

Water may be contaminated with numerous substances considered harmful to human or other life. Microorganisms for example from wastewater, can spread disease among humans. While often a secondary effect of nitrate and/or phosphate contamination algae and other aquatic plants can be another source of contamination. Algae can produce toxins which leach into the water. Furthermore, dead algae and aquatic plans provide a ready food source to other microorganisms and bacteria which are harmful to humans. Pharmaceuticals or hormones can harm biological processes. Minerals and chemicals with harmful cumulative effects can naturally occur or may be present in water distribution systems.

Many industrial or resource extraction operations produce contaminated water. These operations may contaminate water with heavy metals, volatile organic compounds (VOCS), polychlorinated biphenyls (PCBₛ), pharmaceuticals, pesticides, radionuclides, and harmful microorganisms. These and other contaminants must be removed before the water is discharged or it risks contaminating the environment or freshwater resources.

Being a well-known source of harmful microorganisms, water is often treated prior to human consumption. Often drinking water is treated with harsh chemicals in order to eliminate harmful microorganisms that can cause health problems in humans and/or pets. There is growing public concern and caution regarding impact on human health from ingesting the chemicals used to treat water. There are similar concerns regarding the impact of the use of these chemicals on the quality of our natural environment.

### BRIEF DISCLOSURE

An example of a method of in-situ treatment of a body of water with at least one contaminant includes adding a blended water treatment substance to the water comprising at least one contaminant. The blended water treatment substance includes at least one geopolymer and at least one cationic biopolymer. The at least one contaminant is adsorbed from the contaminated water onto the geopolymer. The at least one geopolymer upon which the at least one contaminant is adsorbed is coagulated with the at least one cationic biopolymer. The coagulated at least one geopolymer, at least one biopolymer, and at least one contaminant is precipitated to settle within the water body.

In further examples, the at least one geopolymer is a plurality of geopolymers. The plurality of geopolymers in the blended water treatment substance may include Aragonite in an amount up to 30%, Bentonite in an amount up to 30%, Zeolite in an amount up to 90%, and at least one other additive in an amount 0-20%. The Aragonite may be between 20-30%, the Bentonite may be between 20-30%, and the Zeolite may be between 20-60%. The plurality of geopolymers of the blended water treatment substance may include between 10%-40% particles having diameters between 0.062 mm-4.0 mm and include between 60%-90% particles having diameters between 0.001 mm-0.0625 mm.

In other examples, the at least one other additive includes at least one of: activated carbon, biochar, diatomite, manganese greensand, iron oxide, zero valent iron, titanium dioxide, redox alloys, citric acid, basalt, olivine, peridotite, calcium oxide, serpentinite, magnesite, cellulose, charged lignan, and microorganisms. The at least one other additive may include citric acid and the method may include lowering the pH of the body of water by adding the blended water treatment substance to the water. The at least one contaminant may be algae and the at least one other additive may include microorganisms including anerobic bacteria and the method may include decomposing the algae with the anerobic bacteria after precipitating the coagulated at least one geopolymer, at least one biopolymer, and at least one contaminant. The at least one other additive may include calcium carbonate and the method further includes raising the pH of the body of water by adding the blended water treatment substance to the water.

In additional examples, the plurality of geopolymers of the blended water treatment substance include between 10%-90% particles having diameters between 0.0625 mm-4.0 mm and between 10%-90% particles having diameters between 0.001 mm-0.0625 mm. The plurality of geopolymers of the blended water treatment substance may include between 10%-40% particles having diameters between 0.062 mm-4.0 mm and between 60%-90% particles having diameters between 0.001 mm-0.0625 mm. The plurality of geopolymers of the blended water treatment substance may include 25% particles having diameters between 0.062 mm-4.0 mm and 75% particles having diameters between 0.001 mm-0.0625 mm.

In further examples, a structure permeable to water is formed. The structure is filled with the blended water treatment substance. The structure is placed in a waterway of the body of water. The water enters the structure and a portion of the blended water treatment substance exits the structure into the body of water. The structure may include geotextile. Placing the filled structure in a waterway of the body of water includes positioning the structure filled with the blended water treatment substance along a shore of the body of water, wherein the structure further slows runoff from entering the body of water. Placing the filled structure in a waterway of the body of water includes positioning the structure filled with the blended water treatment substance floating in the body of water. The structure may be a floating boom within the body of water and the method may further include constraining a floating contaminant on the surface of the body of water. The floating contaminant may be exposed to the portion of the blended water treatment substance that exits the structure. A sediment layer may be formed at the bottom of the body of water from the precipitated blended water treatment substance and the at least one contaminant from the contaminated water adsorbed onto the geopolymer of the blended water treatment substance. The at least one contaminant may include algae. The biopolymer may be chitosan or a derivative of chitosan. The at least one geopolymer may first be added to the water comprising at least one contaminant and the at least one cationic biopolymer may then be added to the water comprising at least one contaminant.

### BRIEF DESCRIPTION OF THE DRAWINGS

FIG. 1 is a flow chart that depicts an example of a method of water treatment using geopolymers and biopolymers.

FIG. 2 is a flow chart that depicts an example of a method of water treatment using biopolymers.

FIG. 3 is a flow chart that depicts an example of a method of water treatment using geopolymers.

### DETAILED DISCLOSURE

The present disclosure relates to the treatment of water using biopolymer additives to purify the water from plant, bacteria, viruses, and other microorganism contaminants. The present disclosure also relates to systems and processes of water treatment for not only plant, bacteria, and other microorganism contaminants, but to remove other contaminants including, but not limited to: dissolved solids, suspended solids, heavy metals, volatile organic compounds (VOC's), radionuclides, pesticides, and pharmaceuticals.

US Patent Application Publication No. 2020/0231483, which is incorporated by reference herein in its entirety, describes a method of water treatment that includes providing water that includes at least one contaminant. An effective amount of at least one filter media is added to the water that includes at least one contaminant. The water and the at least one filter media are agitated to form a homogeneous mixture. A cationic biopolymer is added to the homogeneous mixture of water and the at least one filter media. The water is separated from the at least one contaminant and the at least one filter media.

Embodiments as disclosed herein use the combination of a biopolymer and a geopolymer. This combined material is mixed with a water supply to treat the water in a water supply. In examples, the disclosed material combination is added to water bodies in order to modify pH, reduce turbidity, clarify the water, and raise dissolved oxygen levels. Treatments as disclosed herein can oxidize and neutralize harmful algae blooms and their toxins, as well as absorb excess nutrients that promote eutrophication and algae blooms.

Nutrients that may be absorbed or limited in examples of the disclosed process may include, but are not limited to: phosphorus, ammonium, ammonia, nitrogen, and iron. Algae in the forms of blue-green algae, cyanobacteria, red tide, or kerenia brevis, as well as the toxins that they produce (e.g. microcystin, saxitoxin, beta-methylamino-L-alanine (BMAA), brevitoxins, and others) are oxidized, neutralized, and/or sequestered in examples of the disclosed process.

The blended water treatment substance can be formulated to adjust certain water quality characteristics or desired improvements and/or outcomes for example as those noted above. In examples, the geopolymer component of the blended water treatment substance provides at least one active water treatment function. In examples, the geopolymer may be at least one of bentonite, aragonite, and zeolite. In further examples, aragonite may produce an effect of raising pH of the treated water and zeolite may produce an effect of reducing phosphorus in the treated water. Zeolite can provide nitrogen and ammonium sequestration. Inclusion of activated carbon/biochar may absorb certain elements including nitrogen and replenish carbon loss in benthic layers. Water turbidity can be clarified with use of zeolite and bentonite in the blended water treatment substance. A higher aragonite concentration may be beneficial to address acidity and bleaching of coral communities in salt water and brackish water. It will be recognized herein that a blended water treatment substance that uses a blend of the geopolymers bentonite, aragonite, and zeolite has particular utility. In an example, the blended water treatment substance may be mixed at a ratio of two parts sodium bentonite, one part aragonite, and one part zeolite.

Geopolymers are inorganic materials that form covalently bonded amorphous structures. Geopolymers include, but are not limited to silicate, aluminosilicate, phosphosilicate, ferrosilicate materials. Geopolymers can occur naturally or can be manufactured, manufactured geopolymers can also include calcium, fly ash, or organic mineral based geopolymers and others. However, the geopolymers of aragonite, bentonite, and zeolite will be focused on herein.

At least one additive may be combined with the geopolymers of the blended water treatment substance. These further additives may be added to the blended water treatment substance in order to achieve certain secondary outcomes in the treated water, e.g. slow/disrupt/minimize carbon loss in the benthic layer, lower co2 levels in the water, increase oxidation/dissolved oxygen, or increase the health of aquatic life. Diatomite additive can be added to blended water treatment substance in order to enhance clarification of the water column or improve water quality to increase the health of aquatic life. Manganese greensand additive can be used to reduce iron, manganese, and hydrogen sulfide through oxidation, treating or counteracting algae blooms. Iron fixing algae species can promote or propagate harmful algae blooms. Hydrogen sulfide levels are high when algae is decomposing. Elevated levels of iron and manganese in water bodies is further associated with low dissolved oxygen levels and eutrophication. Still further additives absorb CO2 from the water, including, but not limited to basalts, olivine, peridotite, serpentinite, and magnesite.

Calcium oxide can be added to the blended water treatment substance in order to increase oxidative reactions within the water column-primarily the dead zone. The dead zone is saturated with CO₂ and has low or no of oxygen. Once the calcium oxide in combination with the blended water treatment substance reaches the dead zone, the calcium oxide reacts with the CO₂ which creates calcium carbonate (CaCO₃). This removes CO₂, and can release oxygen into the dead zone when the three oxygen molecules of CaCO₃ disassociate into the water column increasing dissolved oxygen levels.

Exemplary embodiments, include other additives for particular water treatment purposes, which include but are not limited to: carbon for removal of VOC's or Pharmaceuticals; zeolite for removal of Phosphates, Nitrates, VOC's, heavy metals, or oils; activated alumina/redox to raise dissolved oxygen levels and remove metals and VOC's; aragonite for selective phosphate removal or antimicrobial purposes; calcium or magnesium to additionally increase pH; diatomite (diatomaceous earth) to improve water clarity or for antimicrobial properties; bentonite or clay for solids, heavy metals or oils.

The blended water treatment substance may further have mineral additives that include but are not limited to oolitic aragonite, chlinoptilotite zeolite, montmorillonite clay (e.g. sodium bentonite and calcium bentonite), activated carbon, biochar, or redox alloys.

The blended water treatment substance further may include a biopolymer as discussed in further detail herein. In examples, the blended water treatment substance is applied to the water to be treated with the geopolymer and the biopolymer simultaneously. In other examples, the biopolymer portion of the blended water treatment substance is applied to the water separately from the geopolymer (and potential additive) component in a sequential method. The geopolymer is exemplarily applied to the water first, followed by the biopolymer.

The biopolymer of chitosan will be used herein in its exemplary capacity, although it will be recognized that other biopolymers having similar properties may be suitable for use in other embodiments. Chitosan is an abundant biopolymer consisting of randomly distributed beta (1->4)-linked D-Glucosamine (deacetylated unit) and N-acetyl-D-Glucosamine (acetylated unit) obtained by the partial deacetylation of chitin. Chitin is found mainly in the exoskeletons of crustaceans and insects, as well as in fungi (e.g. mushrooms and yeasts). At the present time, chitin obtained from shellfish shells stands as the most sustainable and abundant source of chitin in the world, therefore the most abundant and sustainable source of chitosan in the world. Chitin is the second most abundant biopolymer in the world. While chitin is abundant, much of it is discarded as waste from the harvesting or removal of shellfish for industrial, commercial, or consumption purposes.

In embodiments, chitosan and/or chitosan derivatives with or without further materials may be added into a water treatment process as a natural herbicide and pesticide, and to promote efficiency in the water treatment process. Chitosan and chitosan oligosaccharide derivatives can kill harmful bacteria, fungus, fungus gnats, botrytis, thrips, syllids, white flies, citrus greening disease, aphids, nematodes, etc. While exhibiting these anti-microbial properties, chitosan and chitosan oligosaccharide are biocompatabile, biodegradable, and hypo allergenic. See Further Katiyar, Deepmala, et al. “A Future Perspective in Crop Protection: Chitosan and its Oligosaccharides,” Adv Plants Agric Res 2014, 1(1):00006; Doares, Steven H., et al. “Oligogalacturonides and chitosan activate plant defensive genes through the octadecanoid pathway,” Proc. Natl. Acad. Sci. USA Vol. 92, pp. 4095-4098, May 1995 Colloquium Paper; and Malerba, Massimo, et al. “Chitosan Effects on Plant Systems,” Int. J. Mol. Sci. 2016, 17, 996, all of which are hereby incorporated by reference herein in their entireties.

The biopolymer of the blended water treatment substance forms a negatively charged suspended bed that moves through the water column and absorbs excess nutrients, oxidizes and absorbs algae and algae toxins, as well as the nutrients that the algae release, and clarifies the water column. The biopolymer material bonds to the algae, which in turn oxidizes and suffocates the algae, and drops the suspended solids and biomass from the photosynthetic layer to the bottom of the water column. The biopolymer material also coagulates and/or flocs the geopolymer material to which the algae and/or other chemicals or materials adsorb. This agglomeration sinks through the water column. The biopolymer minerals, nutrients, and biomass are metabolized by the benthic community of naturally occurring microorganisms and aquatic plants and animals in a healthy de-stratified, oxygen rich, neutral, balanced ecosystem.

An addition of a positively charged biopolymer including but limited to chitosan and its derivatives changes the charge surface of the biopolymer minerals from negative to positive. This aids in the coagulation and settling speed of solids. The addition of a positively charged coagulant to the biopolymeric mineral formula will aid in the rapid coagulation and setting of the biopolymeric mineral mixture and will help to oxygenate and neutralize hypoxic dead zones by carrying the oxygenating media to the bottom of the water column where the dead zone is located.

The combination of the biopolymer (e.g. chitosan and/or its derivatives) to the geopolymer of the blended water treatment substance further produces a coagulation and flocculation effect of the contaminants bound to or adsorbed upon the geopolymer of the treatment. The concentrations, amounts, and specific variety of biopolymers (e.g. chitosan/chitosan oligosaccharide/chitosan citrate) may be varied based upon the types and compositions of the geopolymer(s) used and the specific contaminants targeted during the process.

In use, the blended water treatment substance is added, for example, by mixing, broadcasting, or spread as will be described herein, into the untreated water, for example in-situ in an outdoor natural environment, for example: creeks, rivers, canals, lakes, ponds, reservoirs, impoundments, river locks, beaches, ports, or seas. Examples of the process described herein may be prescriptive to treat algae blooms or remove other nutrients or contamination. Other examples prophylactic to inhibit future algae blooms or contamination.

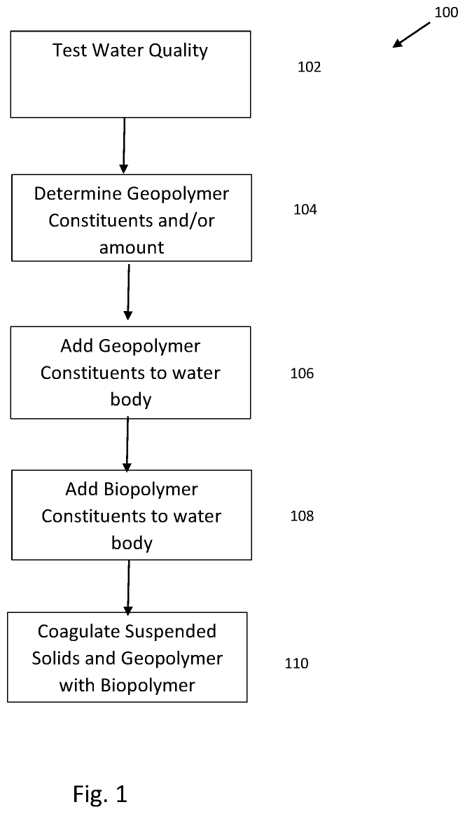

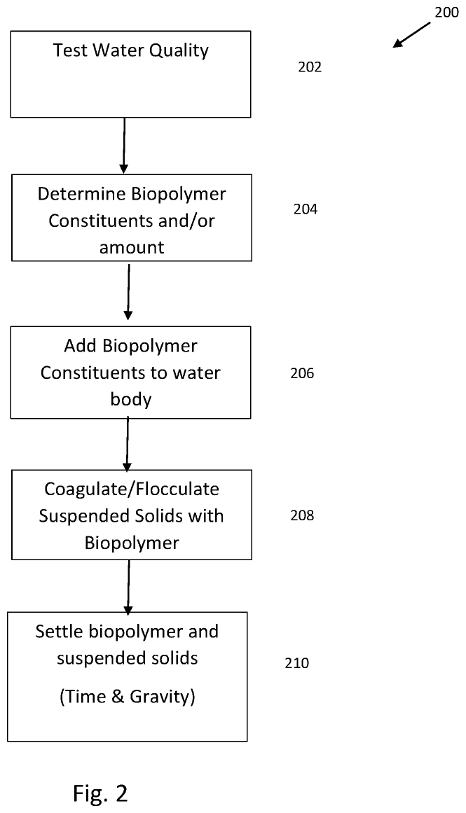

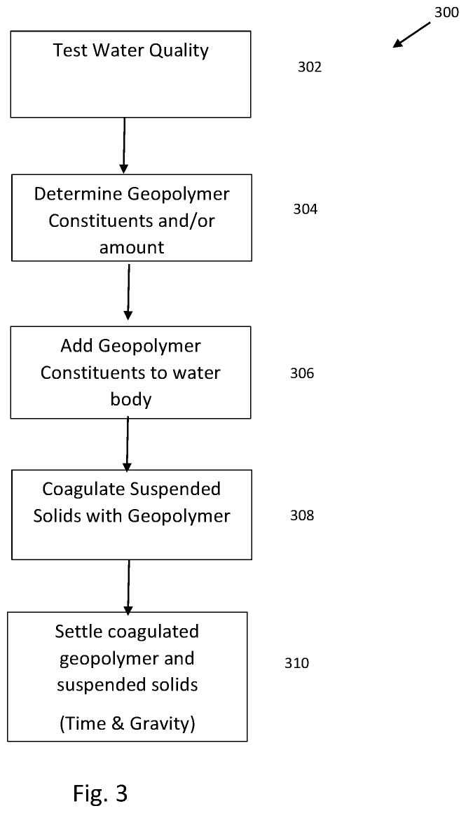

FIG. 1 is a flow chart that depicts an exemplary embodiment of a method 100 of water treatment using the blended water treatment substance. FIGS. 2 and 3 provide still further examples of methods 200, 300 of water treatment. FIG. 2 provides an example of a method 200 of water treatment using biopolymers and FIG. 3 provides an example of a method 300 of water treatment using geopolymers.

At 102, the water quality in the body of water to be treated is optionally tested. In an exemplary embodiment this is performed using a turbidity sensor. Exemplarily, a turbidity sensor may include a light source and a measurement of the scattered and/or received light at a light sensor. This information is provided to a controller. Turbidity is caused by particles suspended or dissolved in water that scatter light making the water appear cloudy or murky. Sediment, organic and inorganic matter, organic compounds, algae, and microscopic organisms are all causes of turbidity. It will be recognized that in other embodiments other or additional water quality measurements may be taken and used by the controller 16 as described herein. The turbidity may exemplarily be measured in Nephlelometric Turbidity Units (NTUs).

The controller is exemplarily a microcontroller and/or a processor that is communicatively connected and/or integrated to a computer readable medium upon which computer readable code in the form of software or firmware is stored. The microcontroller/processor executes the computer readable code and operates to carry out the processing and control functions as described in further detail herein.

The controller operates to determine at 104 at least one geopolymer constituent and/or amount of geopolymer constituent to be added to the water. The geopolymer constituent and/or geopolymer constituent amount is determined based upon the water turbidity and/or other measurement of water quality. It will be recognized that additional water quality or chemical content measurements (and the associated sensors) may be incorporated into the initial water quality testing and the results provided to the controller. Such measurements may identify particular chemicals for removal, for example, phosphorous or nitrogen; other measurements may identify a class of compound for removal, for example VOC's or hydrocarbons; while still other measurements may identify biological, for example algae or bacterial loads for removal. The information from these sensors to the controller, can enable the controller to determine the types and/or amount of geopolymer constituent or other additives as discussed above to use to treat the water in this stage of the process. The geopolymer constituent and/or geopolymer constituent amount may be further determined based upon a treated water quality outcome to be achieved, for example a target clarity, a target pH, or a target dissolved oxygen (DO).

The determined blend of at least one geopolymer and optionally any additives is introduced to the body of water to be treated in a variety of ways at 106. This generally includes mixing, fluid slurry, and dry broadcasting, still further ways of adding the blended water treatment substance are described herein as well. The blended water treatment substance can be mixed directly into flowing water from a point location or locations and entrained in the water flow. In still other examples, the blended water treatment substance may be provided at the shore of the body of water or floating or partially submerged within the body of water in a manner so as to control the infiltrate of water and the exfiltrate of the blended water treatment substance into the body of water therefrom.

The blended water treatment substance can be added in a liquid form by first mixing or agitating the blended water treatment substance in water to homogenize the material/minerals and oxygenated in suspension and then applied by spraying as a fluid/slurry of the suspension. Mixing/agitation techniques such as centrifugal mixing, ultrasonic mixing, and oxygen injection can enhance the oxygenation abilities of the blended water treatment substance when applied. Carbonaceous components of the blended water treatment substance allows the natural pores to be filled with oxygen upon mixing and/or oxygen blending or injection. Still further devices for delivery of the fluid/slurry form of the blended water treatment substance include hydro seeders, sprayers, aerators, liquid line injectors, dosers, or peristaltic pumps.

In still further examples, the blended water treatment substance is mixed/blended and applied in a broadcast as a powder or pellets directly to the water. Oxygen will naturally be released as the water proliferates the pores of the biopolymer mineral material. The blended water treatment substance can be openly applied as a powder or as pellets or granules. Besides broadcast of the blended water treatment substance, the blended water treatment substance may also be delivered through floating or suspended bags or in lined geotextile fabric structures placed in or near the waterway.

In the method 100 of FIG. 1, the biopolymer is added at 108. It will be recognized that the geopolymer of blended water treatment substance may be added sequentially prior to the addition of the biopolymer component of the blended water treatment substance as shown in the method 100, or both the geopolymer component and the biopolymer component of the blended water treatment substance may be added simultaneously. It will be recognized that a fluid or slurry sprayed into the body of water may be a combination of the geopolymer and the biopolymer, or such fluid or slurries may be sequentially application. Similarly, it will be recognized that a broadcast of powdered or granular geopolymer or biopolymer may be done so in a combination or in sequence. However, it will be recognized that when the blended water treatment substance is held within a structure floating in or along the shore of a body of water, that such blended water treatment substance may comprise both the geopolymer and the biopolymer components for simultaneous addition to the body of water.

As noted above, an amount of the chitosan or chitosan derivative needed for the treatment process may be determined by the controller. This determination may also be based upon the information provided from the water quality tests at 102. This determination can further occur at 104, particularly in examples wherein the biopolymer and geopolymer are combined before being introduced to the water. Examples of cationic biopolymers that may be used in embodiments include, but are not limited to chitosan acetate, chitosan malate, chitosan citrate, chitosan formate, and others as may be recognized by a person of ordinary skill in the art in view of this disclosure. The cationic biopolymer may be provided in a concentration of 1-3% solutions of chitosan/chitosan derivative. The amount of the chitosan or chitosan derivative may exemplarily be based upon the turbidity measurement. In an exemplary embodiment, the dosage of chitosan when paired with natural media for selective or broad spectrum contaminant removal is directly proportionate to the turbidity (NTU) created by the addition of the natural media with the water. Heavier solids will require a higher concentration of the chitosan or chitosan derivative to coagulate and form flocs. It will be recognized that in embodiments, the antimicrobial properties of chitosan derivatives may be enhanced or mitigated or otherwise selected for or against depending upon a desired microbial load of the outgoing water from the treatment. In an exemplary embodiment, a stronger antimicrobial compound, for example chitosan acetate, may be used when microbial removal is desired. In other embodiments, a compound with a weaker antimicrobial effect, for example, chitosan malate, may be used if a higher output microbial count is desired, for example for a later aerobic or anaerobic digestion or yeast formation use.

The chitosan/modified chitosan coagulates the suspended contaminants and geopolymer at 110 to effectively separate the contaminants and contaminant laden geopolymer from the clean water. These coagulated flocs naturally sink to the bottom and the clean water stays on the upper layer of separation within the body of water.

The coagulate may be left at the bottom of the body of water, which if left undisturbed can effectively encapsulate the contaminants with the geopolymer and the biopolymer. Application of biopolymeric mineral blend even at high doses along with the settled biomass from algae represents a comparatively minor addition to any sediment that micro life on the benthic layer remains virtually unaffected compared to the shifting of sediment layers in changing water conditions. In other examples, the coagulate can be removed from the bottom of the body of water, or from a lower strata of the body of water by pumps, piping, dredging, screening or other techniques.

While numerous examples are provided herein, the following examples are illustrative of the geopolymer blends which may be used in the examples of the present application. The following are examples of the % (w/w) composition of the geopolymer blends.

| | Aragonite | Bentonite | Zeolite | Other Additives |
|---|---|---|---|---|
| Blend #1 | 20%-30% | 20%-30% | 40%-60% | 0%-20% |
| Blend #2 | 20%-30% | 20%-30% | 20%-30% | 0%-20% |
| Blend #3 | 60%-100% | 0%-40% | 0% | 0%-20% |
| Blend #4 | 5%-30% | 5%-30% | 60%-90% | 0%-20% |

In these examples, the other additives may include but are not limited to activated carbon, biochar, diatomite, manganese greensand, iron oxide, zero valent iron, titanium dioxide, redox alloys, basalt, olivine, peridotite, calcium oxide, serpentinite, magnesite, cellulose, charged lignan, or beneficial microorganisms. Therefore exemplary blends as described herein include 5-100% Aragonite; 0-40% Bentonite, 0-90% Zeolite, with possible 0-20% other additives. As previously noted, the biopolymer may exemplarily be added in an amount of 1%-3%, however other amounts of biopolymer may be recognized as well.

As previously noted, the geopolymer blend may be applied through a variety of mechanisms. Based upon the consideration of delivery mechanism and/or other considerations, the geopolymer blends as disclosed herein may further include variation in the grain size of the constituent geopolymers. Additionally, different sizes of geopolymer can also control the reaction time and the amount of the geopolymer material that reacts with suspended solids while in the water column compared to the amount of the geopolymer is available after settling out of the water column to the bottom of the water body. In one example, the geopolymer blend includes 75% fine powder and 25% sand or granules. In examples, gain size may be based upon the Wentworth scale or ISO 14688-1:2002 may be used to determine grain size. While there is some slight variations in the categories and associated sizes between the Wentworth scale and ISO 14688-1:2002, in general silt and clay particle sizes range between 0.001 mm and 0.004 mm diameter at the small end and 0.0625 mm diameter at the large end. Granule and sand particle sizes similarly range from 0.0625 mm diameter at the small end to between 2.0 mm and 4.0 at the large end. In the example provided above, a blended water treatment substance with a combination of particle sizes has been found to be beneficial in the treatment of in-situ algae. The portion of the blended water treatment substance with larger particle sizes helps to penetrate the algae mat and break it up, while the portion of the blended water treatment substance with smaller particle sizes can better coagulate the suspended solids. The sinking grains helps to create a pulling force to help settle the coagulated geopolymer and algae before the fine powder and larger grain size encapsulate the removed solids. The larger grains further provide a time release effect, continuing to react with nutrients and contaminants after the finer powders have, creating a combination of time scales upon which the treatment is carried out. The table below provides some examples of grain size combinations % (w/w)found in the geopolymer blends.

| | Granules/Sand (size) | Silt/Clay (size) |
|---|---|---|
| Size Blend #1 | 10%-40% | 60%-90% |
| Size Blend #2 | 60%-90% | 10%-40% |
| Size Blend #3 | 40%-60% | 40%-60% |
| Size Blend #4 | 100% | 0% |
| Size Blend #5 | 0% | 100% |

Therefore, examples of the geopolymer blends as provided herein include a combination of 0-100% of a variety in the granule/sand sizes and 0-100% of a variety in the slit/clay size. More specific examples provide a combination of between 10%-90% of both granule/sand size and silt/clay size particles.

FIGS. 2 and 3 provide examples of the respective methods 200, 300 wherein the water is treated with one or the other of biopolymer or geopolymer. It will be recognized that much of the description above with reference to FIG. 1 similarly applies to similar portions of the respective methods 200, 300 in FIGS. 2 and 3. Referring specifically to FIG. 3, the method 300 exemplarily uses a geopolymer blend of aragonite, bentonite, and zeolite. It will be recognized that this combination as described in further detail herein may be used as the geopolymer component in the method of FIG. 1 as well. In an example, the geopolymer blend of aragonite, bentonite, and zeolite is mixed in a slurry and applied to the water body with a hydroseeder (although spray, pellet, or power application may also be used). Given time, this mixture reacts with the suspended solids including algae to coagulate the algae and pull the algae to the bottom of the water body by gravity, settling the algae and associated toxins to the bottom of the water body where they can decompose undisturbed and encapsulated by the aragonite, bentonite, and zeolite of the geopolymer blend. This combination has been found to be particularly effective in the treatment of blue-green algae. Aragonite has been found in experimentation to have a particular affinity for blue-green algae and phosphorus, making it an effective treatment for these blooms and the water conditions that cause these blooms. Aragonite has also been found to raise pH levels.

In examples, the geopolymer treatments as described herein can be used to help to seal/isolate contaminants removed from in-situ bodies of water, for example, wastewater lagoons, irrigation sources, lakes, ponds, and other water bodies by providing an additional geopolymer layer once the treatment material settles to the bottom of the water body. This layer of geopolymer can retain the removed algae or other contaminants within the benthic zone of the body of water. The geopolymer layer at the bottom of the body of water can also help to prevent water loss and groundwater contamination into the water table. In other examples, the biopolymer treatments can help to reduce the populations of mosquito and/or other insects that can transmit disease. The biopolymer of chitosan can kill mosquito larvae as the biopolymer coagulates the geopolymer. Additionally, the reduced eutrophication/algal blooms/turbidity from the biopolymer and/or geopolymer treatments described above reduces the breeding habitat for mosquitos.

In a still further example, the geopolymer, and particularly a geopolymer with an aragonite component may further include the additive of calcium oxide. As explained above, with such an additive and geopolymer blend, the calcium oxide precipitates calcium carbonate, which may make carbon and oxygen molecules available to contribute to the water column to raise dissolved oxygen levels. The release of carbon and/or oxygen by the calcium oxide may further help to oxidize toxins, contaminants, and can further promote the coagulative/flocculative effect when combined with a biopolymer treatment.

Examples disclosed herein may be used to remove algae including cyanobacteria, red-tide, and other nuisance algae species. Beneficial microbes can be added to the biopolymeric mineral formula to digest toxins, solids, nutrients, chelate metals, and etc. when applied to water as a treatment. Beneficial microbes, including but not limited to, aerobic and anaerobic bacteria, endo and ectomycorrhizal fungi, and digestive enzymes which decompose algae and/or the chemicals produced by algae or algae decomposition. The beneficial microbes added to the formula help enhance the soil moisture holding capacity as well as de-stratify the soil strata and sub strata. The beneficial microbes help fix nitrogen from the atmosphere. Less input/demand/use for nitrogen significantly improves the watershed and waterways. The beneficial microbes increase the size of the hyphae, taproot, and entire root structure of plants. The beneficial microbes also increase the absorptive and nutrient cycling abilities of the roots including the uptake and cycling of available phosphorus. This increases drought resistance and decreases the need for additional phosphorus. Less water demand and less phosphorous input requirements also helps to protect the watershed from eutrophication and algae blooms, or poor water quality.

In still further examples, the blended water treatment substances as described herein may further be used a preventative/prophylactic water treatment to maintain conditions in which the body of water is not exemplarily susceptible to algae blooms. Chelating minerals (zeolite, aragonite, bentonite, carbon, as well as biopolymers like chitosan) help lock in the nitrogen and phosphorous at the root zone and helps prevent nutrient migration/runoff and eutrophication and algae blooms in watersheds areas, agriculture, construction, ditches, or retention ponds. The chelating minerals inoculated with beneficial microbes also improves the health and immune functions of the plant/crop which helps protect the plant/crop against pests and disease. This lessens the need for organophosphate pesticides and disease control inputs. This also helps protect the watershed and waterways from eutrophication and algae blooms. On average, soil has lost 90% of its microbial biodiversity, therefore its absorptive capacity and nutrient retention and cycling ability has been considerably diminished. Increasing this biodiversity and combining the benefits of the chelating minerals is a combined approach to protect the watershed and prevent eutrophication and algae blooms.

The blended water treatment substances can be automatically applied to water bodies using for example powered aerators, liquid line injectors, peristaltic pumps, dosers, or mixers as a proactive or reactive measure for nutrient management or the control of algae blooms. Floating or shore based delivery systems with the blended water treatment substances as described herein can be distributed at a body of water or bodies of water. Using sensors, satellites, telemetry, or other data collection technologies, a network of aerators, injectors, mixers, dosers, biopolymer or vessels can be remotely engaged, to apply the blended water treatment substances when an algae bloom is detected or the conditions for a bloom are detected. This can improve the water quality and/or decrease the algae load and nutrients in bodies of water. Improved speed and localization of deployment of blended water treatment substances can therefore be effective in containing and mitigating the spread of algal blooms. mineral biopolymeric mineral media and engage

The blended water treatment substance can be openly applied, injected, distributed, aerated into wastewater sources (e.g lagoons, pits, ponds, etc) to achieve desired water characteristics including, but not limited to: PH buffering, nutrient sequestration, heavy metal leaching, mineral leaching, solids flocculation, coagulation, settling, pathogen control, odor control, or algae control. A similar technique and blended water treatment substance formula can be used to remediate acid mining tailings spills. Floating or suspended booms or geotextiles filled with the blended water treatment substance can also be used to help neutralize PH and absorb/leach metals/minerals/contaminants out of the water/feedstock sources.

As disclosed herein the blended water treatment substance can be applied as a powder, pellet, hydroseeded slurry solution, or within a structure that is at least partly formed by a geotextile barrier as a preventative measure to control nutrient/contaminant run off in water bodies. A structure that is permeable to water may be filled with the blended water treatment substance and positioned on the shore of a body of water to retain runoff, slowing the runoff into the body of water, but also a portion of the water enters the structure and a portion of the blended water treatment substance leaves the structure and enters the body of water, treating the body of water. The biopolymers as described herein have unique characteristics to enhance growth and stress resistance in plants. When utilized to control, mitigate, remediate, nutrient run off, the nutrient laden minerals will further enhance plant growth and stress resistance when used as a soil amendment. This use is a true slow release fertilizer. Limiting nutrient run off, of course, protects the watershed from run off and algae blooms, e-coli, TSS, and etc. Increasing growth and stress resistance factors reduces the need for further chemical inputs that would ultimately run off and cause more blooms.

In still further examples, the blended water treatment substance may be used to neutralize water pH in acidic/high photosynthetic algae bloom areas. Citric acid can be included in the at least one additive to the blended water treatment substance and in a dry or liquid form. Specific levels of calcium oxide, calcium carbonate, or aragonite may be used to increase pH while citric acid used to lower pH. Therefore the blended water treatment substance may further be formulated to achieve desired pH in the body of water following testing and data analysis.

In another example, the geopolymer and biopolymer materials and blends as disclosed herein may be integrated into other products, for example, product packaging, or products intended to be use on, in or near, bodies of water. These may include incorporation of the same into biodegradable plastics. In such examples, the biodegradation of these materials will release the disclosed geopolymer and biopolymers into the surrounding area and water. Incorporation of such materials may help to improve or counteract negative impacts of decomposition on the watershed or associated bodies of water as these and other materials break down, releasing chemicals and nutrients into the environment.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of in-situ treatment of a body of water comprising at least one contaminant, the method comprising:
adding a blended water treatment substance to the body of water in-situ, the blended water treatment substance comprising at least one geopolymer and at least one cationic biopolymer;
adsorbing the at least one contaminant from the contaminated water onto the geopolymer;
coagulating the at least one geopolymer upon which the at least one contaminant is adsorbed with the at least one cationic biopolymer; and
precipitating the coagulated at least one geopolymer, at least one biopolymer, and at least one contaminant to settle within the water body.

2. The method of claim 1, wherein the at least one geopolymer is a plurality of geopolymers and the plurality of geopolymers in the blended water treatment substance comprises:
Aragonite in an amount up to 30%;
Bentonite in an amount up to 30%;
Zeolite in an amount up to 90%; and
at least one other additive in an amount 0-20%.

3. The method of claim 2, wherein the Aragonite is between 20-30%, the Bentonite is between 20-30%, and the Zeolite is between 20-60%.

4. The method of claim 3, wherein the plurality of geopolymers of the blended water treatment substance comprises between 10%-40% particles having diameters between 0.062 mm-4.0 mm and comprises between 60%-90% particles having diameters between 0.001 mm-0.0625 mm.

5. The method of claim 1, wherein the at least one other additive comprises at least one of: activated carbon, biochar, diatomite, manganese greensand, iron oxide, zero valent iron, titanium dioxide, redox alloys, citric acid, basalt, olivine, peridotite, calcium oxide, serpentinite, magnesite, cellulose, charged lignan, and microorganisms.

6. The method of claim 5, wherein the at least one other additive comprises citric acid and the method further comprises:
lowering the pH of the body of water by adding the blended water treatment substance to the water.

7. The method of claim 5, wherein the at least one contaminant is algae and the at least one other additive comprises microbes comprising anerobic bacteria and the method comprises:
decomposing the algae with the anerobic bacteria after precipitating the coagulated at least one geopolymer, at least one biopolymer, and at least one contaminant.

8. The method of claim 5, wherein the at least one other additive comprises calcium oxide and the method further comprises:
raising the pH of the body of water by adding the blended water treatment substance to the water.

9. The method of claim 1, wherein the plurality of geopolymers of the blended water treatment substance comprises between 10%-90% particles having diameters between 0.0625 mm-4.0 mm and between 10%-90% particles having diameters between 0.001 mm-0.0625 mm.

10. The method of claim 9, wherein the plurality of geopolymers of the blended water treatment substance comprises between 10%-40% particles having diameters between 0.062 mm-4.0 mm and between 60%-90% particles having diameters between 0.001 mm-0.0625 mm.

11. The method of claim 10, wherein the plurality of geopolymers of the blended water treatment substance comprise 25% particles having diameters between 0.062 mm-4.0 mm and 75% particles having diameters between 0.001 mm-0.0625 mm.

12. The method of claim 1, further comprising:
forming a structure permeable to water;
filling the structure with the blended water treatment substance; and
placing the filled structure in a waterway of the body of water;
wherein water enters the structure, and a portion of the blended water treatment substance exits the structure into the body of water.

13. The method of claim 12, wherein the structure comprises geotextile.

14. The method of claim 12, wherein placing the filled structure in a waterway of the body of water comprises positioning the structure filled with the blended water treatment substance along a shore of the body of water, wherein the structure further slows runoff from entering the body of water.

15. The method of claim 12, wherein placing the filled structure in a waterway of the body of water comprises positioning the structure filled with the blended water treatment substance floating in the body of water.

16. The method of claim 15, wherein the structure is a floating boom within the body of water and further comprising:
constraining a floating contaminant on the surface of the body of water; and
exposing the floating contaminant to the portion of the blended water treatment substance that exits the structure.

17. The method of claim 1, further comprising:
forming a sediment layer at the bottom of the body of water from the precipitated blended water treatment substance and the at least one contaminant from the contaminated water adsorbed onto the geopolymer of the blended water treatment substance.

18. The method of claim 1, wherein the at least one contaminant comprises algae.

19. The method of claim 1, wherein the biopolymer is chitosan or a derivative of chitosan.

20. The method of claim 1, wherein adding the blended water treatment substance to the water comprises:
first adding the at least one geopolymer to the water comprising at least one contaminant; and
then adding the at least one cationic biopolymer to the water comprising at least one contaminant.
